(19) United States
(12) Patent Application Publication
(10) Pub. No.: US 2026/0255223 A1
(43) Pub. Date: Aug. 27, 2026

(54) OPERATION OF A CONFINED AREA RADIO ACCESS NETWORK BRIDGE CELL

(71) Applicant: Telefonaktiebolaget LM Ericsson (publ), Stockholm (SE)

(72) Inventors: Fredrik WOXBERG, Västra Frölunda (SE); Lisa BOSTRÖM, Solna (SE); Juan-Antonio IBANEZ, Solna (SE); Walter MÜLLER, Upplands Väsby (SE)

(73) Assignee: Telefonaktiebolaget LM Ericsson (publ), Stockholm (SE)

(21) Appl. No.: 18/878,004

(22) PCT Filed: Dec. 21, 2022
(86) PCT No.: PCT/SE2022/051221

§ 371 Date: Dec. 20, 2024

Related U.S. Application Data
(60) Provisional application No. 63/367,589, filed on Jul. 1, 2022.

(51) Int. Cl. H04W 36/00

(52) U.S. Cl. CPC H04W 36/0016; H04W 36/0022; H04W 36/0058; H04W 36/0061

(57) ABSTRACT

A confined area (CA) radio access network (RAN) comprises a bridge cell, that enables mobility for user equipment (UE) between the CA RAN and a wide area (WA) RAN. The bridge cell broadcasts within a carrier configuration used by the WA RAN a cell information signal that comprises a cell identifier. The WA RAN may then obtain a measurement report including the identifier of the bridge cell from a UE served by the WA RAN, and send a handover request to the CA RAN for the UE to be handed over from the WA RAN to the CA RAN. Mobility between WA RAN, and the CA RAN is thereby enabled also when the configurations with respect to power, frequency, etc. differ between the two networks, with exception of the bridge cell.

### TECHNICAL FIELD

Embodiments presented herein relate to a method, a confined area network node, a computer program, and a computer program product for operating a confined area radio access network bridge cell. Embodiments presented herein further relate to a method, a wide area network node, a computer program, and a computer program product for facilitating handover of a user equipment from a wide area radio access network to a confined area radio access network.

### BACKGROUND

Confined Area (CA) Networks (NW) can be deployed either to establish local private service coverage or to extend public service coverage. A CA NW is limited in its geographical reach compared to Wide Area (WA) NWs with ubiquitous coverage, and can for example be a NW deployed in industrial premises, shopping malls, transport hubs, etc. CA NWs often provide indoor service coverage but may also provide outdoor service, such at outdoor parking areas, industrial sites, etc. FIG. 1 schematically illustrates a system 100 in which one WA NW and one or more CA NWs operate. Each of the WA NW and the one or more CA NWs are in FIG. 1 represented by their service coverage; the WA NW has service coverage 110 and the one or more different CA NWs have service coverages 120a, 120b, 120c, 120d, 120e. Each service coverage 110, 120a: 120e will hereinafter be represented by one or more WA radio access network (RAN) cells and CA RAN cells, respectively (although there in a practical realization might be a plurality of WA RAN cells, belonging to the same or different WA RAN network, spanning the service coverage 110, etc.).

Unlicensed or locally licensed spectrum for use in CA NWs is being allocated in many markets to allow enterprises, building owners, etc., to build local coverage more independently of traditional Communication Service Providers (CSPs) delivering Public services in WA NWs. Licensed spectrum could also be utilized in a CA NW, e.g. by deploying a CA NW in collaboration with a CSP or sub-leasing the spectrum. WA NWs are typically built using CSP specific licensed spectrum.

In many cases, one and the same user equipment may be served by both the WA NW and the CA NW (however, maybe not at the same time). User equipment may therefore need to transition between being serviced by the WA NW and serviced by the CA NW whilst connectivity is maintained. This requires user mobility between WA NWs and CA NWs.

To support efficient user mobility between WA NWs and CA NWs, the WA NW might need to support cooperability with, and have knowledge of, many external NW “neighbors” (one per each CA NW), each with potentially multiple CA NW cells neighboring the WA NW cells, possibly operating on other frequencies than the WA NW. CA NWs might be deployed more or less anywhere and a WA NWs would therefore need to instruct its served user equipment to listen for possible available CA NWs (often on other frequencies) throughout the WA NW. This causes significant impact on, for example, NW performance and planning and also the battery consumption of the user equipment.

One way to mitigate these issues is to require use of the WA NW (licensed) spectrum for mobility also within the CA NW (e.g., applying Multi-Operator Radio Access Network techniques to support user equipment from multiple CSPs). This not only drives up the radio cost but also introduces CSP dependencies for the operator of the CANW.

Another way to mitigate these issues is to reduce the mobility performance (e.g., requiring user equipment to reconnect when moving between being served by a WA NW and a CANW). This could cause service disruptions for the user equipment. An example of this is illustrated in FIG. 2. In FIG. 2 is at 200 schematically illustrated a cell 110a in a first WA RAN, a cell 110b in a second WA RAN, and a cell 120a in a CA RAN. Each of the first WA RAN, the second WA RAN, and the CA RAN has its own operating frequency. A reconnect procedure might be performed for user equipment entering the cell 120a from either of the cells 110a, 110b. One trigger for the user equipment to initiate the reconnect procedure would be a radio link failure (RLF) occurring when the user equipment leaves the cell 110a, thus losing coverage. The user equipment might miss the opportunity to connect to the CA RAN altogether unless WA RAN instructs the user equipment to search for the cell 120a. This is battery consuming.

Hence, there is still a need for an improved user mobility between WA NWs and CA NWs.

### SUMMARY

An object of embodiments herein is to address the above issues. A particular object is to enable user mobility between WA NWs and CA NWs that does not suffer from the issues disclosed above, or at least where the above disclosed issues have been mitigated or reduced.

According to a first aspect there is presented a method for operating a CA RAN bridge cell. The CA RAN bridge cell bridges a WA RAN with a CA RAN. The method is performed by a CA network node. The CA network node is controlling the CA RAN. The method comprises broadcasting a cell information signal in the CA RAN bridge cell. The cell information signal comprises a cell identifier used by the CA RAN bridge cell. The cell information signal is broadcast within carrier configuration used by the WA RAN.

According to a second aspect there is presented a CA network node for operating a CA RAN bridge cell. The CA RAN bridge cell bridges a WA RAN with a CA RAN. The CA network node is configured to control the CA RAN. The CA network node comprises processing circuitry. The processing circuitry is configured to cause the CA network node to broadcast a cell information signal in the CA RAN bridge cell. The cell information signal comprises a cell identifier used by the CA RAN bridge cell. The cell information signal is broadcast within carrier configuration used by the WA RAN.

According to a third aspect there is presented a CA network node for operating a CA RAN bridge cell. The CA RAN bridge cell bridges a WA RAN with a CA RAN. The CA network node is configured to control the CA RAN. The CA network node comprises a broadcast module configured to broadcast a cell information signal in the CA RAN bridge cell. The cell information signal comprises a cell identifier used by the CA RAN bridge cell. The cell information signal is broadcast within carrier configuration used by the WA RAN.

According to a fourth aspect there is presented a computer program for operating a CA RAN bridge cell, the computer program comprising computer program code which, when run on processing circuitry of a CA network node, causes the CA network node to perform a method according to the first aspect.

According to a fifth aspect there is presented a method for facilitating handover of a user equipment from a WA RAN to a CA RAN. The method is performed by a WA network node. The WA network node is controlling the WA RAN. The method comprises obtaining a measurement report from a user equipment served by the WA RAN. The measurement report comprises a cell identifier used in the CA RAN. The method comprises providing a handover request to a CA network node controlling the CA RAN for the user equipment to be handed over from the WA RAN to the CA RAN.

According to a sixth aspect there is presented a WA network node for facilitating handover of a user equipment from a WA RAN to a CA RAN. The WA network node is configured to control the WA RAN. The WA network node comprises processing circuitry. The processing circuitry is configured to cause the WA network node to obtain a measurement report from a user equipment served by the WA RAN. The measurement report comprises a cell identifier used in the CA RAN. The processing circuitry is configured to cause the WA network node to provide a handover request to a CA network node controlling the CA RAN for the user equipment to be handed over from the WA RAN to the CA RAN.

According to a seventh aspect there is presented a WA network node for facilitating handover of a user equipment from a WA RAN to a CA RAN. The WA network node is configured to control the WA RAN. The WA network node comprises an obtain module configured to obtain a measurement report from a user equipment served by the WA RAN. The measurement report comprises a cell identifier used in the CA RAN. The WA network node comprises a provide module configured to provide a handover request to a CA network node controlling the CA RAN for the user equipment to be handed over from the WA RAN to the CA RAN.

According to an eighth aspect there is presented a computer program for facilitating handover of a user equipment from a WA RAN to a CA RAN, the computer program comprising computer program code which, when run on processing circuitry of a WA network node, causes the WA network node to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects enable, or at least improve, user mobility between WA NWs and CA NWs.

Advantageously, these aspects do not suffer from the issues disclosed above.

Advantageously, these aspects minimize planning efforts for, and/or performance impacts on, the WA NW.

Advantageously, these aspects remove the need for user equipment served by the WA NW to perform additional measurements to search for CA NWs, which would impact battery consumption, time critical service performance, etc.

Advantageously, according to these aspects, CA RAN bridge cells can be configured to support downlink transmissions that a user equipment served by a WA NWs expects. For example, the CA RAN bridge cells can be configured to support multiple SSB transmissions and PCI planning aligned to match one or more WA NWs.

Advantageously, these aspects enable the use of WA NW-specific carrier frequencies within the CA NW (except at the CA RAN bridge cell) to be avoided, thereby reducing interference from the CA RAN towards the WA RAN.

Advantageously, these aspects enable easy detection of the CA RAN for a user equipment operatively connected to the WA RAN.

Advantageously, these aspects enable deployments of CA NWs to be independent of WANWs.

Advantageously, these aspects enable Automated Neighbor Relations (ANR) techniques to be used in the WA RAN for detecting the CA RAN bridge cell.

Advantageously, these aspects enable seamless mobility of user equipment from the WA RAN to the CA RAN.

Advantageously, since the main purpose of the CA RAN bridge cell is to enable mobility of user equipment between the WA RAN and the CA RAN, the implementational and computational cost of the CA RAN bridge cell can be kept relatively small.

Advantageously, the CA RAN bridge cell could operate at lower output power than a regular cell due to the limited coverage and services offered by the CA RAN bridge cell.

Advantageously, operation of the CA RAN bridge cell needs only to be maintained at certain times, depending on where the CA NW is deployed. For example, if the CA NW is deployed at a shopping mall, the CA RAN bridge cell needs only to be operable during the opening hours of the shopping mall.

Other objectives, features and advantages of the enclosed embodiments will be apparent from the following detailed disclosure, from the attached list of enumerated embodiments as well as from the drawings.

Generally, all terms used in the list of enumerated embodiments are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1 to 8 are schematic illustrations of WA and CA networks according to embodiments;

FIGS. 9 and 10 are flowcharts of methods according to embodiments;

FIGS. 11 and 12 are signalling diagrams according to embodiments;

FIG. 13 is a schematic diagram showing functional units of a CA network node according to an embodiment;

FIG. 14 is a schematic diagram showing functional modules of a CA network node according to an embodiment;

FIG. 15 is a schematic diagram showing functional units of a WA network node according to an embodiment;

FIG. 16 is a schematic diagram showing functional modules of a WA network node according to an embodiment; and

FIG. 17 shows one example of a computer program product comprising computer readable means according to an embodiment.

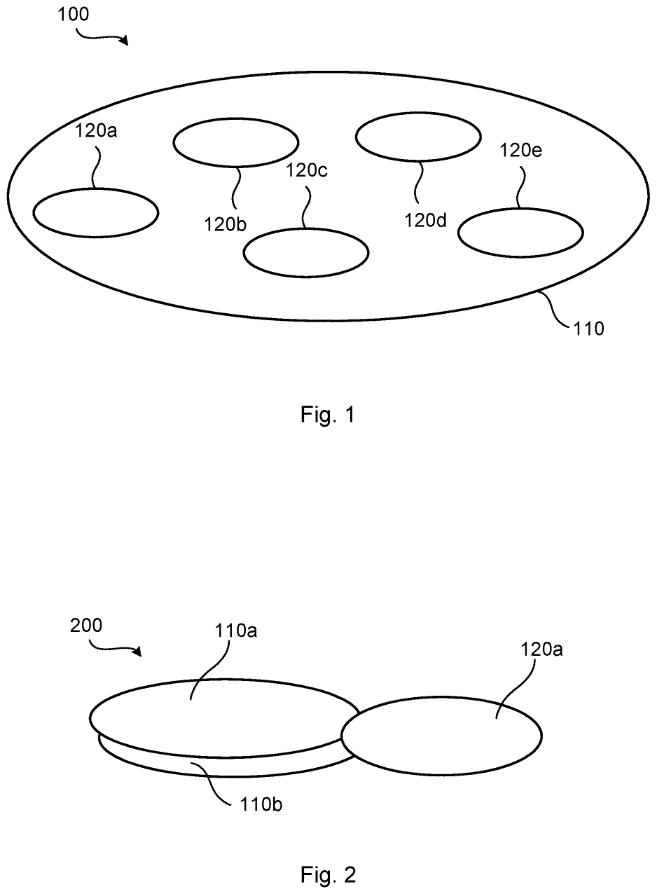

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

When configuring the WA NW and the CA NW for mobility it is less complex for a CA NW to be configured for mobility towards one surrounding WA NW than to configure a WA NW for mobility towards many independently installed CA NWs. For example, as disclosed above, if user equipment served by the WA NW would have to search for all CA NWs, this would degrade not only the WA NW but also negatively impact the performance of the user equipment (e.g., causing battery drain due to the user having to perform measurements, and/or loss in throughput for the user equipment).

According to the herein disclosed embodiments, CA RAN bridge cells are therefore introduced. One or more CA RAN bridge cell might be operated in specific locations where mobility between the WA NW and the CA NW needs to be optimized, with minimal impact on WA NW planning and configuration. A CA RAN bridge cell can thus be placed at key locations at the border between the WA NW and the CA NW (e.g. at the entrance of a building if the CA NW is operated inside the building). The CA RAN bridge cells are administratively part of the CA NW, but are configured to be detectable by user equipment operatively connected to the WA RAN, and to enable efficient mobility into the CA RAN. The CA RAN bridge cells are therefore configured to enable user equipment operatively connected to the WA RAN to efficiently detect the CA NW and allow the CA NW to efficiently steer the transition of the user equipment from the WA RAN to the CA RAN, which typically operate on other frequencies than, at least some of, the WA RAN cells.

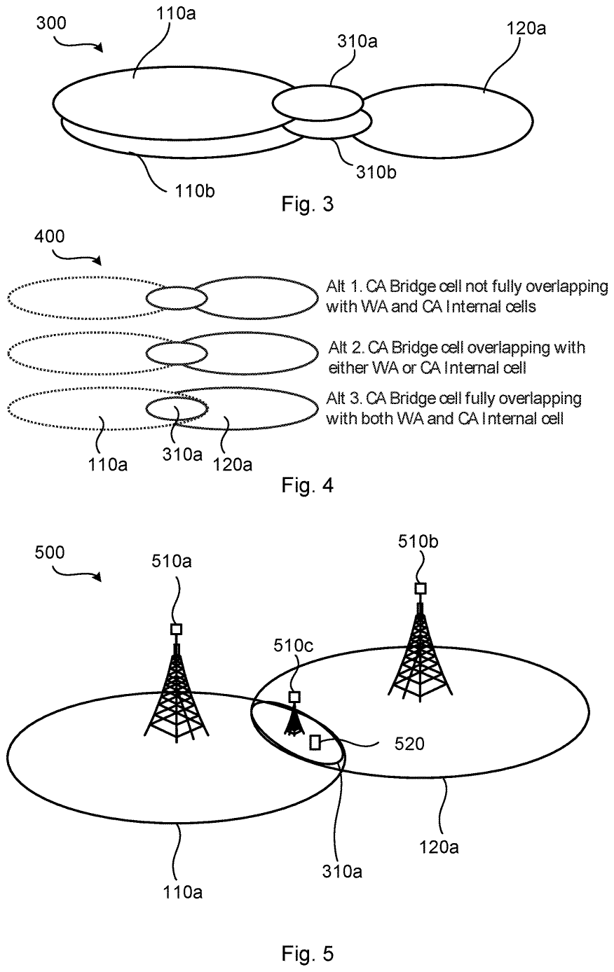

In FIG. 3 is at 300 schematically illustrated a cell 110a in a first WA RAN, a cell 110b in a second WA RAN, and a cell 120a in a CA RAN. Each of the first WA RAN, the second WA RAN, and the CA RAN has its own operating frequency. In FIG. 3 is also shown a first CA RAN bridge cell 310a and a second CA RAN bridge cell 310b. User equipment enters the CA NW via either the first bridge cell 310a or the second bridge cell 310b, depending on if the user equipment comes from the cell 110a or the cell 110b. In general terms, by means of the CA RAN bridge cells 310a, 310b, user equipment served by a WA NW will, using existing WA NW mobility services, automatically find any available CA NW. As will be further disclosed below, CA RAN bridge cells 310a, 310b can either be configured as a normal WA RAN cell (but managed from the CA NW) to let user equipment entering the CA RAN temporarily camp on the CA RAN bridge cell 310a, 310b during transition, or to only broadcast information required to make the CA RAN detectable to the user equipment, after which the WA NW and the CA NW then can hand over (or redirect) the user equipment directly between a WA RAN cell and an internal CA RAN cell (thus without the user equipment temporarily camping on the CA RAN bridge cell 310a, 310b).

In FIG. 4 is at 400 schematically illustrated three examples of a cell 110a in a WA RAN, a cell 120a in a CA RAN, and a CA RAN bridge cell 310a. Each example illustrates a respective alternative with respect to how the CA RAN bridge cell 310a overlaps with the cell 110a in the WA RAN and the cell 120a in the CA RAN. According to the first alternative, the RAN bridge cell 310a partly, but not fully, overlaps with the cell 110a and partly, but not fully, overlaps with the cell 120a. According to a second alternative, the RAN bridge cell 310a fully overlaps with one, but not both, of the cells 110a, 120a, and partly overlaps with the other of the cells 110a, 120a. According to a third alternative, the RAN bridge cell 310a fully overlaps with both the cells 110a, 120a. As will be further disclosed below, the amount of overlap between the CA RAN bridge cell 310a and the cells 110a, 110b in the WA RAN and the CA RAN might impact how the CA RAN bridge cell 310a is configured (e.g., whether the user equipment will camp on the CA RAN bridge cell or be directly redirected to an internal CA RAN cell, as will be disclosed in further detail below.

In FIG. 5 is at 500 schematically illustrated one realization of a cell 110a in a WA RAN, a cell 120a in a CA RAN, and a CA RAN bridge cell 310a. Each cell 110a, 120a, 310a is served by its own respective access point 510a, 510b, 510c. Non-limiting examples of access points are radio access network nodes, radio base stations, base transceiver stations, node B, evolved node B, gNBs, access nodes, transmission and reception points, integrated access and backhaul nodes. As will be further disclosed below, the access points 510a:510c are operatively connected to one or more core networks (CNs). In one example, it is assumed that the access point 510a is operatively connected to a WA NW domain CN whereas the access points 510b, 510c are operatively connected to a CA NW domain CN. In FIG. 5 is further shown a user equipment 520 located in the CA RAN bridge cell 310a. Non-limiting examples of user equipment are portable wireless devices, mobile stations, mobile phones, handsets, wireless local loop phones, smartphones, laptop computers, tablet computers, wireless modems, wireless modules, wireless sensor devices, network-equipped vehicles, Internet-of-Things (IOT) devices, head-mounted displays, etc.

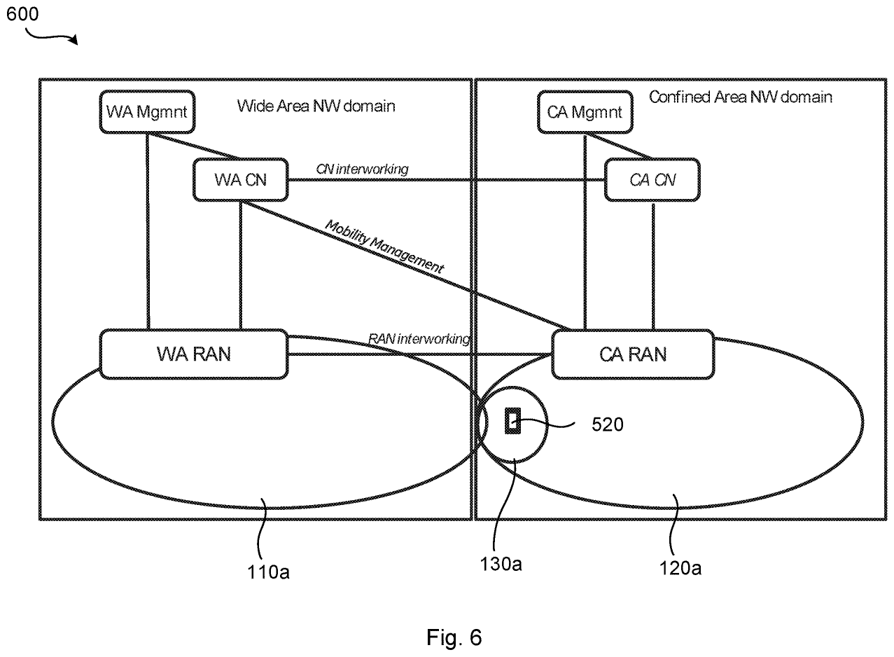

In FIG. 6 is at 600 schematically illustrated a WA NW domain and a CA NW domain. In the WA NW domain is provided a WA management (Mgmt) system, a WA CN, and a WA RAN that are interconnected with each other. In the CA NW domain is provided a CA management system, a CA CN, and a CA RAN that are interconnected with each other. CN interworking information is exchanged between the WA CN and the CA CN. RAN interworking information is exchanged between the WA RAN and the CA RAN. Mobility management information is exchanged between the WA CN and the CA RAN.

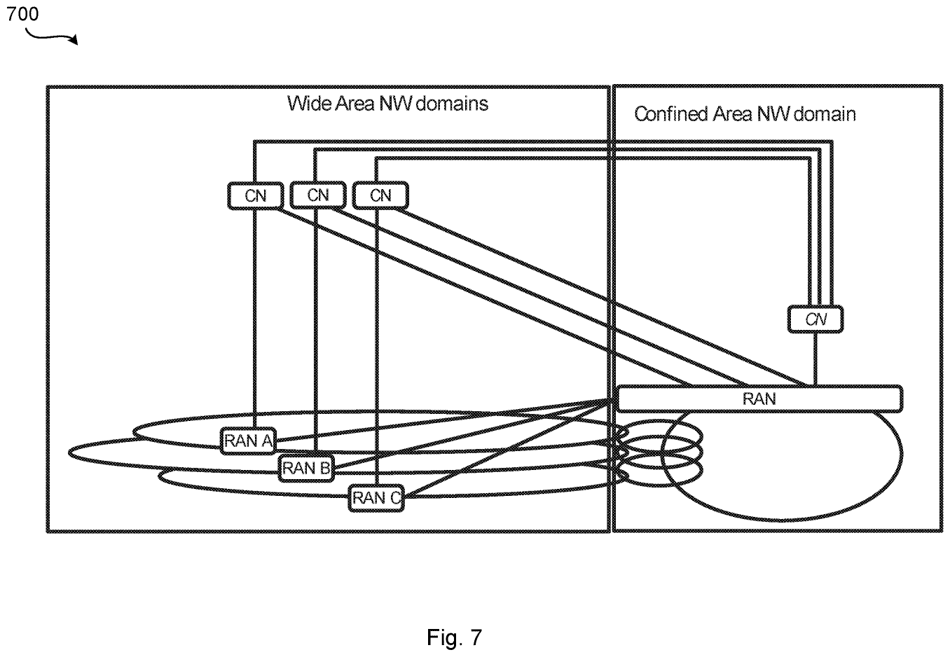

In FIG. 7 is at 700 schematically illustrated a similar view as in FIG. 6 but without any management systems and where there are three different WA RANs (denoted “RAN A”, “RAN B” and “RAN C”), each with their own CN, where the CN of each WA RAN is operatively connected to the CA CN and the CA RAN, and where each WA RAN is operatively connected to the CA RAN. As schematically illustrated in FIG. 7, there is thus one CA RAN bridge cell for each of the three WA RANs. One reason for this that each of the CA RAN bridge cells uses one or more of the frequencies utilized in the respective WA NWs. Since there are three WA RANs illustrated in FIG. 7, this implies that at least three CA RAN bridge cells need to be deployed so as to match each specific WA RAN with respect to mobility planning and handling. The CA RAN bridge cells might then be regarded as acting as a Multi-Operator Radio Access Network (MORAN) configured shared RAN (operating at WA RAN carrier frequencies), whilst the internal cells (i.e., those cells that are not bridge cells) in the CA RAN could be configured as a Multi-Operator Core Network (MOCN) shared RAN (operating at CA NW carrier frequencies). The MOCN shared RAN inside the CA NW could have one or more frequency layers (which could for example be, but is not limited to, spectrum owned by one of the CSPs, private spectrum or shared spectrum such as Citizens Broadband Radio Service; CBRS).

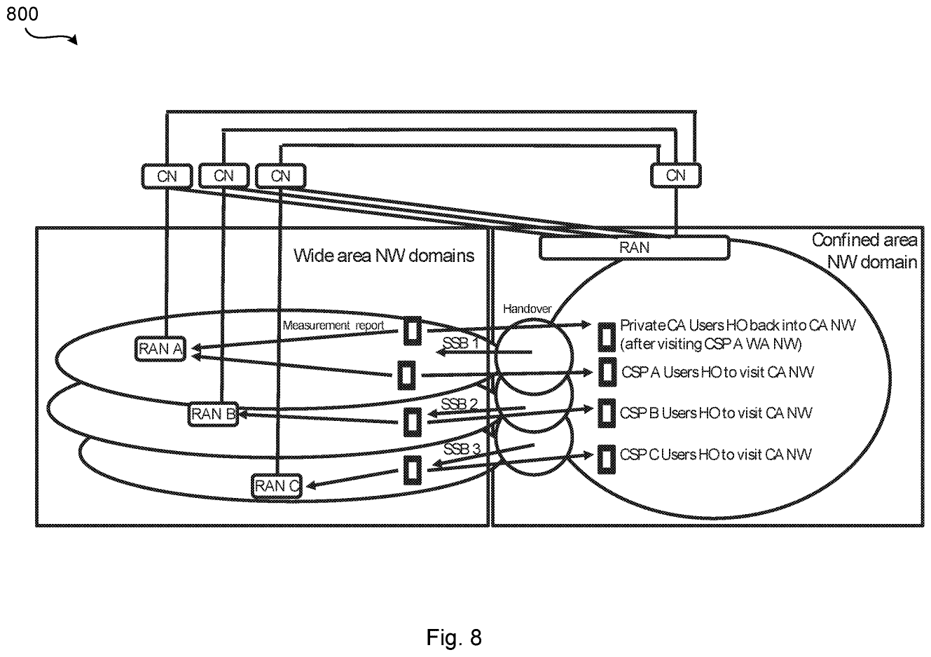

In FIG. 8 is at 800 schematically illustrated the same view as in FIG. 7 with the addition of also showing broadcasting of a respective synchronization signal block (SSB) in the CA RAN bridge cells. In particular, SSB 1 is broadcast in the CA RAN bridge cell for WA RAN A, SSB 2 is broadcast in the CA RAN bridge cell for WA RAN B, and SSB 3 is broadcast in the CA RAN bridge cell for WA RAN C. As further schematically illustrated, user equipment will provide a measurement report for any received SSB back to its serving WA RAN. The reception of such a measurement report at the WA RAN might trigger the user equipment to he handed over to the CA RAN for the user equipment to visit the CA NW. In the example of FIG. 8, the CA RAN thus use broadcast of multiple SSBs (one for each WA RAN) so that user equipment operatively connected to any of the WA RAN easily can find and detect the CA RAN cells (e.g., blindly without the use of measurement gap as if they were normal intra frequency related WA RAN cells or inter frequency WA RAN cells). Further, if one or more of the WA RANs use additional SSBs per WA RAN cell, then also the CA RAN bridge cells could be adapted so that additional SSBs are coordinatingly transmitted from the same CA RAN bridge cell, e.g., for seamless handover support between the WA NW and the CA NW.

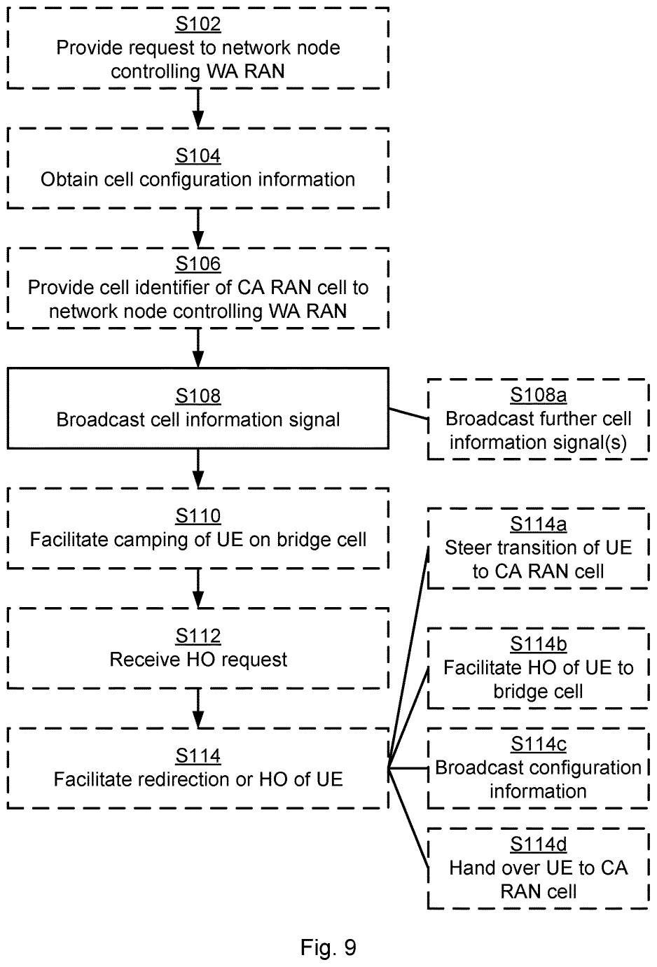

Reference is now made to FIG. 9 illustrating a method for operating a CA RAN bridge cell as performed by a CA network node according to an embodiment. The CA RAN bridge cell bridges a WA RAN with a CA RAN. The CA network node is controlling the CA RAN.

S108: The CA network node broadcasts a cell information signal in the CA RAN bridge cell. The cell information signal comprises a cell identifier used by the CA RAN bridge cell. The cell information signal is broadcast within a carrier configuration used by the WA RAN.

Embodiments relating to further details of operating a CA RAN bridge cell as performed by the CA network node will now be disclosed.

Aspects of the carrier configuration will be disclosed next. In this respect, cells might generally be identifiable not only by the cell information but also the frequency used for transmitting the cell information. The carrier configuration might therefore pertain to on which frequency the cell information signal is broadcast. Further, the cell information signal generally has a certain time placement within transmitted subframes. In other words, the cell information signal is transmitted during a particular time instant, such as at a particular symbol, or resource, in time. The carrier configuration might therefore pertain to placement of the cell information signal within the subframe. Further, for New Radio (NR) type telecommunication systems also the subcarrier spacing can be used to identify the cell. The carrier configuration might therefore pertain to sub-carrier spacing used in the WA RAN. In Long Term Evolution (LTE) type telecommunication systems the same sub-carrier spacing is used in all cells.

There could be different types of cell identifiers. In some embodiments, the cell identifier is a physical cell identity, PCI, used in the CA RAN. Cells can be identified by user equipment by the network requesting the user equipment to read the Global Cell identifier (ID) broadcast and report that ID back to the network. Hence, in some embodiments, the cell identifier is a global cell identity, broadcast as part of system information of the CA RAN bridge cell.

There could be different types of cell information signals. In some embodiments, the cell information signal is an SSB, and/or is composed of a primary synchronization signal (PSS) and a secondary synchronization signal (SSS).

To support mobility between the WA NW and the CA NW, relationships and interfaces between the WA NW and the CA NW might need to be established. In particular, in some embodiments, the CA network node is configured to perform (optional) steps S102, S104, and S106.

S102: The CA network node provides a request to a WA network node controlling the WA RAN to approve the CA RAN bridge cell.

S104: The CA network node obtains cell configuration information of the WA RAN from the WA network node controlling the WA RAN.

S106: The CA network node provides the cell identifier used in the CA RAN, such as for example used by the CA RAN bridge cell, to the WA network node controlling the WA RAN.

The cell information signal can then be broadcast in accordance with the cell configuration information obtained in step S104.

As in the example of FIG. 7, there might be two or more WA RANs, with one CA RAN bridge cell per each WA RAN. Hence, in some embodiments, at least one further CA RAN bridge cell bridges a respective further WA RAN with the CA RAN. In some embodiments, the CA network node is then configured to perform (optional) step S108a as part of step S108.

S108a: The CA network node broadcasts, in each at least one further CA RAN bridge cell, a further cell information signal for a respective one of the at least one further WA RAN. The further cell information signal for a given further WA RAN comprises a cell identifier used for the CA RAN bridge cell for the given further WA RAN. The further cell information signal for the given further WA RAN is broadcast within a carrier configuration of the given further WA RAN. The CA RAN can adapt mobility actions, e.g., cell setup/handover/Release-With-Redirect, etc. to be suitable per WA RAN so that a certain user equipment coming from a certain WA RAN is suitably configured when arriving to the CA RAN.

It is further envisioned that there might be two or more CA RANs (either where each CA RAN has its own CA CN or where two or more CA RANs share a common CA CN), but that the two or more CA RANs might share one and the same CA RAN bridge cell. Hence, in some embodiments, the CA RAN bridge cell further bridges the WA RAN with at least one further CA RAN. The cell information signal then comprises a respective cell identifier from each CA RAN.

Combinations of networks with two or more WA RANs and two or more CA RANs are also envisioned.

In some aspects, the CA RAN bridge cell is configured to enable user equipment to temporarily camp on it during transition. Hence, in some embodiments, the CA network node is configured to perform (optional) step S110.

S110: The CA network node facilitates idle mode or inactive mode camping of a user equipment on the CA RAN bridge cell.

In some aspects it is assumed that the CA network node receives a handover request for a user equipment to be handed over from the WA RAN to the CA RAN. In particular, in some embodiments, the CA network node is configured to perform (optional) steps S112 and S114.

S112: The CA network node receives a handover request from a WA network node controlling the WA RAN for a user equipment to be handed over from the WA RAN to the CA RAN.

S114: The CA network node facilitates redirection, or handover, of the user equipment from the WA RAN to the CA RAN.

In this respect, redirection involves the user equipment going from connected mode to idle/inactive mode, i.e., from being served by a WA RAN cell to being camping on CA RAN cell. Handover involves the user equipment staying in connected mode and changing from being served in a WA RAN cell to being served in a CA cell.

There can be different ways in which the transition of the user equipment is steered between the CA RAN bridge cell and an internal CA RAN cell.

In some aspects, release with re-direct or handover of the user equipment from the WA RAN cell directly to the internal CA RAN cell can be performed. For example, the CA RAN bridge cell might only be configured to transmit broadcasts (for example, but not limited to, SSBs) for user equipment to detect the CA RAN via measurements performed by the user equipment on the broadcast signals. For example, the CA RAN might determine the user equipment to be handed over from the WA RAN cell to an overlapping CA RAN cell directly without the user equipment first temporarily camping on the CA RAN bridge cell. The CA RAN bridge cell then only needs to be configured to enabling the user equipment to detect the CA RAN which triggers a handover procedure. In particular, in some embodiments, the CA network node is configured to perform (optional) step S114a as part of facilitating redirection, or handover, of the user equipment from the WA RAN to the CA RAN in (optional) step S114.

S114a: The CA network node steers transition of the user equipment to the CA RAN from the WA RAN directly without facilitating camping of the user equipment on the CA RAN bridge cell.

In some aspects, the user equipment is first handed over from the WA RAN cell to the CA RAN bridge cell and then from the CA RAN bridge cell to the internal CA RAN cell. In some examples, the CA RAN bridge cell is therefore configured to enable user equipment to temporarily camp on the CA RAN bridge cell as part of the handover from the WA RAN to the CA RAN. In particular, in some embodiments, the CA network node is configured to perform (optional) steps S114b, S114c, S114d as part of facilitating redirection, or handover, of the user equipment from the WA RAN to the CA RAN in (optional) step S114.

S114b: The CA network node facilitates handover of the user equipment to the CA RAN bridge cell from the WA RAN,

S114c: The CA network node broadcasts information in the CA RAN bridge cell to configure the user equipment for measurements to be performed by the user equipment on the CA RAN, such as on the CA RAN bridge cell, to trigger transition of the user equipment to the CA RAN, and

S114d: The CA network node hands over the user equipment from the CA RAN bridge cell to the CA RAN.

What option is most suitable depends, for example, on the coverage of the CA RAN bridge cell and its relation to the coverage of the cells in the WA RAN and the internal cells (i.e., those cells that are not bridge cells) in the CA NW. With reference again made to FIG. 4, according to the first alternative, the user equipment needs to temporarily camp on the CA RAN bridge cell, which thus needs to be equipped with full cell role capabilities (camping, Pcell, etc.). However, in the second and third alternatives, the CA RAN bridge cell might (optionally) be configured only with capabilities of broadcasting (for example, but not limited to, SSB). Further in this respect, the camping strategy (in both the WA NW and the CA NW) might be impacted depending on the information shared between the WA NW and the CA NW.

In addition, the CA NW may support different type of handovers internally in the CA RAN where some handovers might be seamless between the CA NW internal cells and if possible also at the transition between the WA NW and the CA NW, as disclosed above.

In some examples, the WA RAN comprises a WA RAN cell operatively connected to a WA core network, and the CA RAN comprises a CA RAN cell operatively connected to a CA core network being different from the WA core network. Further examples of how the WA RAN, the WA core network, the CA RAN, and the CA core network might be interconnected have been disclosed above with reference to FIGS. 6, 7, 8.

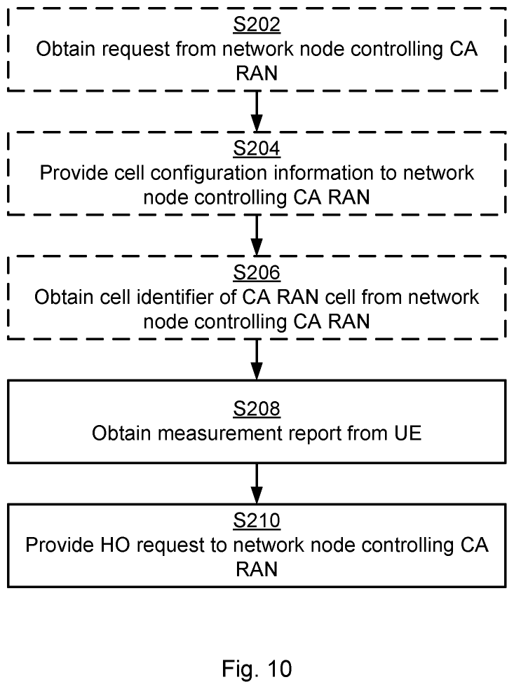

Reference is now made to FIG. 10 illustrating a method for facilitating handover of a user equipment from a WA RAN to a CA RAN as performed by the WA network node according to an embodiment. The WA network node is controlling the WA RAN.

S208: The WA network node obtains a measurement report from a user equipment served by the WA RAN. The measurement report comprises a cell identifier used in the CA RAN.

S210: The WA network node provides a handover request to a CA network node controlling the CA RAN for the user equipment to be handed over from the WA RAN to the CA RAN.

Embodiments relating to further details of facilitating handover of a user equipment from a WA RAN to a CA RAN as performed by the WA network node will now be disclosed.

Before the WA network node performs the actual handover of the user equipment to the CA RAN, the WA network node might first query the CA network node if handover of the user equipment will be accepted by the CA network node or not. This might be the case where the CA NW is a network belonging to an enterprise, and where only user equipment associated with the enterprise are allowed to access the CA NW. Hence, in some embodiments, the handover request comprises a query for the CA network node controlling the CA RAN whether the user equipment is allowed access to the CA NW or not. The query might therefore comprise an identifier of the user equipment.

As disclosed above, to support mobility between the WA NW and the CA NW, relationships and interfaces between the WA NW and the CA NW might need to be established. In particular, in some embodiments, the WA network node is configured to perform (optional) steps S202, S204, S206.

S202: The WA network node obtains a request from the CA network node controlling the CA RAN. The request is for the WA network node to approve a CA RAN bridge cell controlled by the CA network node, for a cell information signal to be broadcast in the CA RAN bridge cell. The cell information signal comprises a cell identifier used in the CA RAN (such as for example used by the CA RAN bridge cell). The cell information signal is to be broadcast within carrier configuration used by the WA RAN.

S204: The WA network node provides cell configuration information of the WA RAN to the CA network node controlling the CA RAN. The cell configuration information comprises information of the carrier configuration used by the WA RAN.

S206: The WA network node obtains the cell identifier of the CA RAN bridge cell from the CA network node controlling the CA RAN.

The cell identifier received in the measurement report in S208 might then be checked against a list of possible cell identifiers obtained from the CA network node. The WA network node can thereby verify that the cell identifier received in the measurement report in S208 is a genuine cell identifier.

PCI planning and/or Automated Neighbor Relations Cell Global Identifier reading can be used to make it possible for the WA NW to identify SSB transmission(s) as belonging to a certain CA RAN to e.g., resolve Internet protocol (IP) address to use for signalling between WA RAN and the CA RAN.

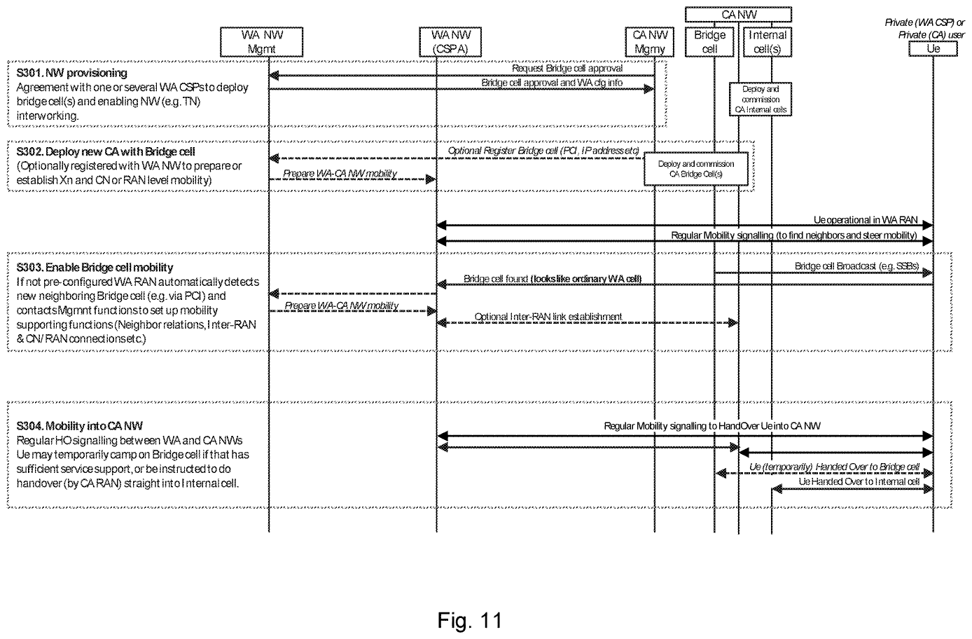

As disclose above, to support mobility between NWs (such as between the WA NW and the CA NW), relationships and interfaces between the different NWs might need to be established. A procedure to prepare, set-up and make CA RAN bridge cells detectable is outlined in the signalling diagram of FIG. 11.

S301: NW provisioning. In this step, relationships and interfaces between the WA NW and the CA NW are established. The WA NW management (Mgmt) system and the CA NW Mgmt system reaches an agreement to deploy one or more CA RAN bridge cells and enable interworking between the WA NW and the CANW.

S302: Deploy new CA with bridge cell. A CA RAN bridge cell is deployed and is optionally registered with the WA NW.

S303: Enable bridge cell mobility. Mobility of user equipment in the WA RAN to the CA RAN is enabled using the CA RAN bridge cell.

S304: Mobility into CA NW. A user equipment is handed over from the WA RAN to the CA RAN using regular handover signalling. The user equipment might temporarily camp on the CA RAN bridge cell or be handed over directly from a WA RAN cell to an internal CA RAN cell.

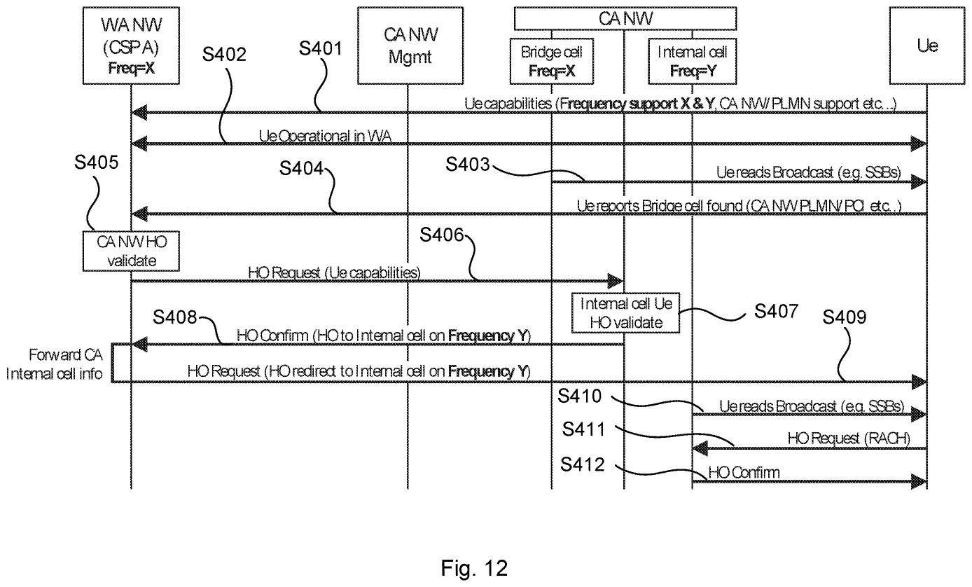

A handover procedure for a user equipment from the WA RAN to the CA RAN via a CA RAN bridge cell for the third alternative in FIG. 4 is outlined in the signalling diagram of FIG. 12.

S401: User equipment capabilities (such as frequency support (for frequencies X and Y, for example), CA NW support etc.) is provided from the user equipment to the WA NW.

S402: The user equipment is operational in the WANW.

S403: The user equipment reads an SSB as broadcast by the CA RAN bridge cell.

S404: The user equipment reports the found CA RAN bridge cell (e.g., in terms of CA NW PCI, etc.).

S405: The WA NW validates a handover to be made to the CA NW.

S406: The WA NW provides a handover (HO) request with the user equipment capabilities to the CA NW.

S407: The CA NW validates whether the handover should be allowed or not.

S408: The CA NW confirms that the handover is to be allowed and provides information that the handover is to be made on frequency Y to the internal CA RAN cell.

S409: The CA NW informs the user equipment that it is redirected to the internal CA RAN cell and that frequency Y is to be used.

S410: The user equipment reads broadcast information (e.g., in an SSB) from the internal CA RAN cell.

S411: The user equipment sends a handover request on a random access channel (RACH) to the internal CA RAN cell.

### S412: the Internal Ca Ran Cell Confirms the Handover.

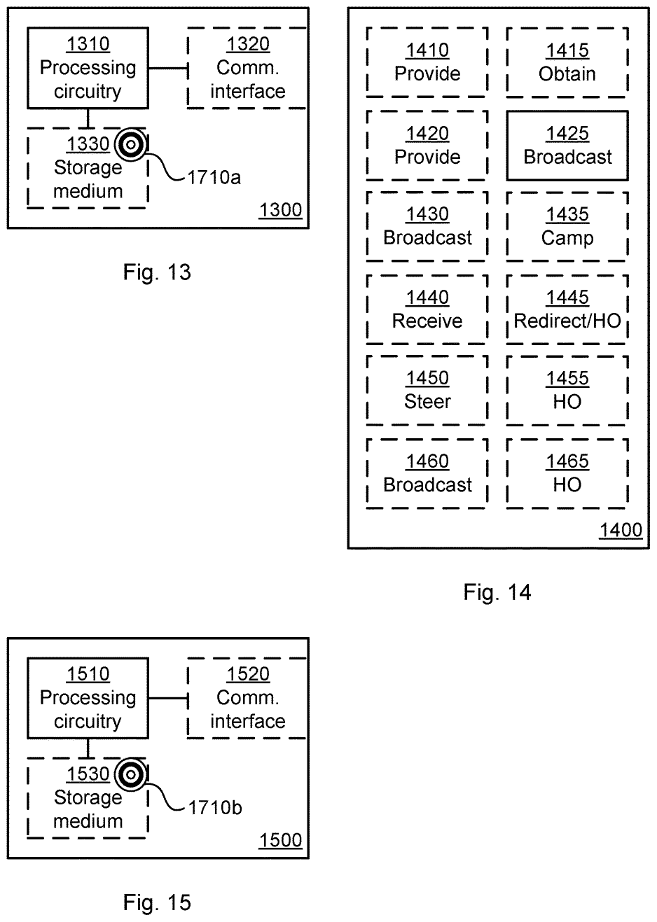

FIG. 13 schematically illustrates, in terms of a number of functional units, the components of a CA network node 1300 according to an embodiment. Processing circuitry 1310 is provided using any combination of one or more of a suitable central processing unit (CPU), multiprocessor, microcontroller, digital signal processor (DSP), etc., capable of executing software instructions stored in a computer program product 1710a (as in FIG. 17), e.g. in the form of a storage medium 1330. The processing circuitry 1310 may further be provided as at least one application specific integrated circuit (ASIC), or field programmable gate array (FPGA).

Particularly, the processing circuitry 1310 is configured to cause the CA network node 1300 to perform a set of operations, or steps, as disclosed above. For example, the storage medium 1330 may store the set of operations, and the processing circuitry 1310 may be configured to retrieve the set of operations from the storage medium 1330 to cause the CA network node 1300 to perform the set of operations. The set of operations may be provided as a set of executable instructions. Thus the processing circuitry 1310 is thereby arranged to execute methods as herein disclosed.

The storage medium 1330 may also comprise persistent storage, which, for example, can be any single one or combination of magnetic memory, optical memory, solid state memory or even remotely mounted memory.

The CA network node 1300 may further comprise a communications interface 1320 for communications with other entities, functions, nodes, and devices. As such the communications interface 1320 may comprise one or more transmitters and receivers, comprising analogue and digital components.

The processing circuitry 1310 controls the general operation of the CA network node 1300 e.g. by sending data and control signals to the communications interface 1320 and the storage medium 1330, by receiving data and reports from the communications interface 1320, and by retrieving data and instructions from the storage medium 1330. Other components, as well as the related functionality, of the CA network node 1300 are omitted in order not to obscure the concepts presented herein.

FIG. 14 schematically illustrates, in terms of a number of functional modules, the components of a CA network node 1400 according to an embodiment. The CA network node 1400 of FIG. 14 comprises a broadcast module 1425 configured to perform step S108. The CA network node 1300 of FIG. 14 may further comprise a number of optional functional modules, such as any of a provide module 1410 configured to perform step S102, an obtain module 1415 configured to perform step S104, a provide module 1420 configured to perform step S106, a broadcast module 1430 configured to perform step S108a, a camp module 1435 configured to perform step S110, a receive module 1440 configured to perform step S112, a redirect/HO module 1445 configured to perform step S114, a steer module 1450 configured to perform step S114a, a HO module 1455 configured to perform step S114b, a broadcast module 1460 configured to perform step S114c, and a HO module 1465 configured to perform step S114d.

In general terms, each functional module 1410:1465 may be implemented in hardware or in software. Preferably, one or more or all functional modules 1410:1465 may be implemented by the processing circuitry 210, possibly in cooperation with the communications interface 220 and/or the storage medium 230. The processing circuitry 210 may thus be arranged to from the storage medium 230 fetch instructions as provided by a functional module 1410:1465 and to execute these instructions, thereby performing any steps of the CA network node 1400 as disclosed herein.

FIG. 15 schematically illustrates, in terms of a number of functional units, the components of a WA network node 1500 according to an embodiment. Processing circuitry 1510 is provided using any combination of one or more of a suitable central processing unit (CPU), multiprocessor, microcontroller, digital signal processor (DSP), etc., capable of executing software instructions stored in a computer program product 1710b (as in FIG. 17), e.g. in the form of a storage medium 1530. The processing circuitry 1510 may further be provided as at least one application specific integrated circuit (ASIC), or field programmable gate array (FPGA).

Particularly, the processing circuitry 1510 is configured to cause the WA network node 1500 to perform a set of operations, or steps, as disclosed above. For example, the storage medium 1530 may store the set of operations, and the processing circuitry 1510 may be configured to retrieve the set of operations from the storage medium 1530 to cause the WA network node 1500 to perform the set of operations. The set of operations may be provided as a set of executable instructions. Thus the processing circuitry 1510 is thereby arranged to execute methods as herein disclosed.

The storage medium 1530 may also comprise persistent storage, which, for example, can be any single one or combination of magnetic memory, optical memory, solid state memory or even remotely mounted memory.

The WA network node 1500 may further comprise a communications interface 1520 for communications with other entities, functions, nodes, and devices. As such the communications interface 1520 may comprise one or more transmitters and receivers, comprising analogue and digital components.

The processing circuitry 1510 controls the general operation of the WA network node 1500 e.g. by sending data and control signals to the communications interface 1520 and the storage medium 1530, by receiving data and reports from the communications interface 1520, and by retrieving data and instructions from the storage medium 1530. Other components, as well as the related functionality, of the WA network node 1500 are omitted in order not to obscure the concepts presented herein.

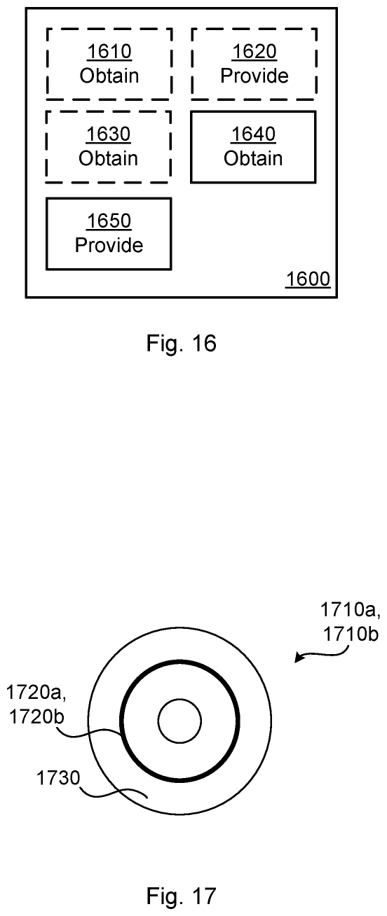

FIG. 16 schematically illustrates, in terms of a number of functional modules, the components of a WA network node 1600 according to an embodiment. The WA network node 1600 of FIG. 16 comprises a number of functional modules; an obtain module 1640 configured to perform step S208, and a provide module 1650 configured to perform step S210. The WA network node 1600 of FIG. 16 may further comprise a number of optional functional modules, such as any of an obtain module 1610 configured to perform step S202, a provide module 1620 configured to perform step S204, and an obtain module 1630 configured to perform step S206.

In general terms, each functional module 1610:1650 may be implemented in hardware or in software. Preferably, one or more or all functional modules 1610:1650 may be implemented by the processing circuitry 310, possibly in cooperation with the communications interface 320 and/or the storage medium 330. The processing circuitry 310 may thus be arranged to from the storage medium 330 fetch instructions as provided by a functional module 1610:1650 and to execute these instructions, thereby performing any steps of the WA network node 1600 as disclosed herein.

The CA network node 1300/WA network node 1500 may be provided as a standalone device or as a part of at least one further device. For example, the CA network node 1300/WA network node 1500 may be provided in a respective RAN node or in a respective CN node, alternatively in a combined RAN and CN node.

Alternatively, functionality of the CA network node 1300/WA network node 1500 may be distributed between at least two devices, or nodes. These at least two nodes, or devices, may either be part of the same network part (such as the RAN or the CN) or may be spread between at least two such network parts. In general terms, instructions that are required to be performed in real time may be performed in a device, or node, operatively closer to the cells than instructions that are not required to be performed in real time. Thus, a first portion of the instructions performed by the CA network node 1300/WA network node 1500 may be executed in a first device, and a second portion of the instructions performed by the CA network node 1300/WA network node 1500 may be executed in a second device; the herein disclosed embodiments are not limited to any particular number of devices on which the instructions performed by the CA network node 1300/WA network node 1500 may be executed. Hence, the methods according to the herein disclosed embodiments are suitable to be performed by a CA network node 1300/WA network node 1500 residing in a cloud computational environment. Therefore, although a single processing circuitry 210, 310 is illustrated in FIGS. 13 and 15 the processing circuitry 1310, 1510 may be distributed among a plurality of devices, or nodes. The same applies to the functional modules 1410:1465, 1610:1650 of FIGS. 14 and 16 and the computer programs 1720a, 1720b of FIG. 17.

FIG. 17 shows one example of a computer program product 1710a, 1710b comprising computer readable means 1730. On this computer readable means 1730, a computer program 1720a can be stored, which computer program 1720a can cause the processing circuitry 210 and thereto operatively coupled entities and devices, such as the communications interface 220 and the storage medium 230, to execute methods according to embodiments described herein. The computer program 1720a and/or computer program product 1710a may thus provide means for performing any steps of the CA network node 1300, 1400 as herein disclosed. On this computer readable means 1730, a computer program 1720b can be stored, which computer program 1720b can cause the processing circuitry 310 and thereto operatively coupled entities and devices, such as the communications interface 320 and the storage medium 330, to execute methods according to embodiments described herein. The computer program 1720b and/or computer program product 1710b may thus provide means for performing any steps of the WA network node 1500, 1600 as herein disclosed.

In the example of FIG. 17, the computer program product 1710a, 1710b is illustrated as an optical disc, such as a CD (compact disc) or a DVD (digital versatile disc) or a Blu-Ray disc. The computer program product 1710a, 1710b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1720a, 1720b is here schematically shown as a track on the depicted optical disk, the computer program 1720a, 1720b can be stored in any way which is suitable for the computer program product 1710a, 1710b.

The inventive concept has mainly been described above with reference to a few embodiments. However, as is readily appreciated by a person skilled in the art, other embodiments than the ones disclosed above are equally possible within the scope of the inventive concept, as defined by the appended list of enumerated embodiments.

1. A method for operating a confined area (CA) radio access network (RAN) bridge cell, wherein the CA RAN bridge cell bridges a wide area (WA) RAN with a CA RAN, wherein the method is performed by a CA network node, wherein the CA network node is controlling the CA RAN, and wherein the method comprises:
broadcasting a cell information signal in the CA RAN bridge cell, wherein the cell information signal comprises a cell identifier used by the CA RAN bridge cell, and wherein the cell information signal is broadcast within a carrier configuration used by the WA RAN.

2. The method according to claim 1, wherein the cell identifier is a physical cell identity (PCI) used in the CA RAN.

3. The method according to claim 1, wherein the cell information signal is a synchronization signal block (SSB); the cell information signal is composed of a primary synchronization signal (PSS) and a secondary synchronization signal (SSS); or the cell information signal is a SSB and the cell information signal is composed of a PSS and a SSS.

4. The method according to claim 1, wherein the cell identifier is a global cell identity, broadcast as part of system information of the CA RAN bridge cell.

5. The method according to claim 1, wherein the method further comprises:
facilitating idle mode or inactive mode camping of a user equipment on the CA RAN bridge cell.

6. The method according to claim 1, wherein the method further comprises:
receiving a handover request from a WA network node controlling the WA RAN for a user equipment to be handed over from the WA RAN to the CA RAN; and
facilitating redirection or handover of the user equipment from the WA RAN to the CA RAN.

7. The method according to claim 6, wherein facilitating redirection or handover of the user equipment from the WA RAN to the CA RAN further comprises:
steering transition of the user equipment to the CA RAN from the WA RAN directly without facilitating camping of the user equipment on the CA RAN bridge cell.

8. The method according to claim 6, wherein facilitating redirection or handover of the user equipment from the WA RAN to the CA RAN further comprises:
facilitating handover of the user equipment to the CA RAN bridge cell from the WA RAN,
broadcasting information in the CA RAN bridge cell to configure the user equipment for measurements to be performed by the user equipment on the CA RAN to trigger transition of the user equipment to the CA RAN, and
handing over the user equipment from the CA RAN bridge cell to the CA RAN.

9. The method according to claim 1, wherein the method further comprises:
providing a request to a WA network node controlling the WA RAN to approve the CA RAN bridge cell;
obtaining cell configuration information of the WA RAN from the WA network node controlling the WA RAN; and
providing the cell identifier used in the CA RAN to the WA network node controlling the WA RAN.

10. The method according to claim 9, wherein the cell information signal is broadcast in accordance with the cell configuration information.

11. The method according to claim 1, wherein at least one further CA RAN bridge cell bridges a respective further WA RAN with the CA RAN, and wherein the method further comprises:
broadcasting, in each at least one further CA RAN bridge cell, a further cell information signal for a respective one of the further WA RAN, wherein the further cell information signal for a given further WA RAN comprises a cell identifier used for the CA RAN bridge cell for the given further WA RAN, and wherein the further cell information signal for the given further WA RAN is broadcast within a carrier configuration of the given further WA RAN.

12. (canceled)

13. The method according to claim 1, wherein the WA RAN comprises a WA RAN cell operatively connected to a WA core network, and the CA RAN comprises a CA RAN cell operatively connected to a CA core network being different from the WA core network.

14. A method for facilitating handover of a user equipment from a wide area (WA) radio access network (RAN) to a confined area (CA) RAN, wherein the method is performed by a WA network node, wherein the WA network node is controlling the WA RAN, and wherein the method comprises:
obtaining a measurement report from a user equipment served by the WA RAN, wherein the measurement report comprises a cell identifier used in the CA RAN; and
providing a handover request to a CA network node controlling the CA RAN for the user equipment to be handed over from the WA RAN to the CA RAN.

15-16. (canceled)

17. A confined area (CA) network node for operating a CA radio access network (RAN) bridge cell, wherein the CA RAN bridge cell bridges a wide area (WA) RAN with a CA RAN, wherein the CA network node is configured to control the CA RAN, and the CA network node comprising:
processing circuitry; and
a storage medium containing instructions which, when executed by the processing circuitry, to cause the CA network node to:
broadcast a cell information signal in the CA RAN bridge cell, wherein the cell information signal comprises a cell identifier used by the CA RAN bridge cell, and wherein the cell information signal is broadcast within a carrier configuration used by the WA RAN.

18. (canceled)

19. The CA network node according to claim 17, wherein the cell identifier is a physical cell identity (PCI) used in the CA RAN.

20-22. (canceled)

23. A non-transitory computer-readable storage medium comprising a computer program, for operating a confined area (CA radio access network (RAN) bridge cell, wherein the CA RAN bridge cell bridges a wide area (WA) RAN with a CA RAN, the computer program comprising computer code which, when run on processing circuitry of a CA network node controlling the CA RAN, causes the CA network node to perform operations comprising:
broadcasting a cell information signal in the CA RAN bridge cell, wherein the cell information signal comprises a cell identifier used by the CA RAN bridge cell, and wherein the cell information signal is broadcast within a carrier configuration used by the WA RAN.

24-25. (canceled)

26. The CA network node according to claim 17 further to:
receive a handover request from a WA network node controlling the WA RAN for a user equipment to be handed over from the WA RAN to the CA RAN; and
facilitate redirection or handover of the user equipment from the WA RAN to the CA RAN.

27. The CA network node according to claim 26, wherein to facilitate redirection or handover of the user equipment from the WA RAN to the CA RAN further to:
steer transition of the user equipment to the CA RAN from the WA RAN directly without facilitating camping of the user equipment on the CA RAN bridge cell.

28. The CA network node according to claim 26, wherein to facilitate redirection or handover of the user equipment from the WA RAN to the CA RAN further to:
facilitate handover of the user equipment to the CA RAN bridge cell from the WA RAN,
broadcast information in the CA RAN bridge cell to configure the user equipment for measurements to be performed by the user equipment on the CA RAN to trigger transition of the user equipment to the CA RAN, and
hand over the user equipment from the CA RAN bridge cell to the CA RAN.

29. The CA network node according to claim 17 further to:
provide a request to a WA network node controlling the WA RAN to approve the CA RAN bridge cell;
obtain cell configuration information of the WA RAN from the WA network node controlling the WA RAN; and
provide the cell identifier used in the CA RAN to the WA network node controlling the WA RAN.
